(19) United States
(12) Patent Application Publication
(10) Pub. No.: US 2026/0133052 A1
(43) Pub. Date: May 14, 2026

(54) METHODS AND APPARATUS FOR PROVIDING MAPS FOR USE WITH AUTONOMY SYSTEMS

(71) Applicant: Nuro, Inc., Mountain View, CA (US)

(72) Inventors: William Paul Maddern, Queensland (AU); Gregory Long, Mountain View, CA (US); Ning Xu, Santa Clara, CA (US); Peiyan Gong, Los Altos, CA (US); Samuel Maxwell Bateman, Mountain View, CA (US); Haicheng Charles Zhao, Sunnyvale, CA (US); Yi Yang, Foster City, CA (US); Xuran Zhao, Santa Clara, CA (US); Christopher Beall, San Jose, CA (US); Tiffany Huang, Irvine, CA (US); Eleonor Concepcion, Mountain View, CA (US)

(21) Appl. No.: 18/941,048

(22) Filed: Nov. 8, 2024

Related U.S. Application Data
(60) Provisional application No. 63/597,624, filed on Nov. 9, 2023.

(51) Int. Cl. G01C 21/00; B60W 60/00

(52) U.S. Cl. CPC G01C 21/3859; G01C 21/3815; G01C 21/3885; B60W 60/00; B60W 2556/40

(57) ABSTRACT

According to one aspect, a method includes obtaining at least a first map from at least a first map source on a first map arrangement, processing the at least first map to generate a first set of data, and providing the first set of data to a vehicle, wherein the vehicle includes an autonomy system and at least one sensor. The method also includes obtaining a second set of data from the at least one sensor, and processing the first set of data and the second set of data using a second map arrangement, the first map arrangement and the second map arrangement forming a map engine arrangement, wherein processing the first set of data and the second set of data causes a high definition (HD) map to be generated.

### PRIORITY CLAIM

This patent application claims the benefit of priority under 35 U.S.C. § 119 to U. S Provisional Ser. No. 63/597,624, filed Nov. 9, 2023, and entitled “METHODS AND APPARATUS FOR USING MACHINE LEARNING TO PROVIDE MAPS FOR USE WITH AUTONOMY SYSTEMS,” which is incorporated herein by reference in its entirety.

### TECHNICAL FIELD

The disclosure relates to providing maps for use with autonomous vehicles. More particularly, the disclosure relates to using multiple map data sources, in addition to sensor data from a vehicle, to create a high definition map for use by an autonomy system of a vehicle.

### BACKGROUND

In order for vehicles to drive autonomously, maps of environments in which the vehicles operate are used to facilitate the safe operation of the vehicles. The accuracy of the maps used to facilitate autonomous driving is critical, as an inaccurate or incomplete map may lead to performance issues such as safety concerns. However, the generation and maintenance of high definition (HD) maps is typically resource-intensive and expensive.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a system which uses map data sources and vehicle sensor data to create a high definition (HD) map that may be used by an autonomy system of a vehicle in accordance with an embodiment.

FIG. 5 is diagrammatic representation of a map engine arrangement in accordance with an embodiment.

FIG. 6A is a diagrammatic representation of components of a map engine arrangement, e.g., map engine arrangement 550 of FIG. 5, in accordance with an embodiment.

FIG. 6B is a diagrammatic representation of components of a map engine arrangement, e.g., map engine arrangement 550 of FIG. 5, providing data to an autonomy system in accordance with an embodiment.

FIG. 7 is a process flow diagram which illustrates a method of generating an HD map for use with an autonomy system in accordance with an embodiment.

FIG. 8 is a diagrammatic representation of an off-vehicle HD map arrangement, e.g., off-vehicle HD map arrangement 552 of FIG. 2, which accounts for entropy loss in accordance with an embodiment.

FIG. 9 is a process flow diagram which illustrates a general method of providing an HD map for use by an autonomy system of a vehicle in accordance with an embodiment.

### DESCRIPTION OF EXAMPLE EMBODIMENTS

### GENERAL OVERVIEW

According to one embodiment, a method includes obtaining at least a first map from at least a first map source on a first map arrangement, processing the at least first map to generate a first set of data, and providing the first set of data to a vehicle, wherein the vehicle includes an autonomy system and at least one sensor. The method also includes obtaining a second set of data from the at least one sensor, and processing the first set of data and the second set of data using a second map arrangement, the first map arrangement and the second map arrangement forming a map engine arrangement, wherein processing the first set of data and the second set of data causes a high definition (HD) map to be generated.

In another embodiment, a vehicle includes a chassis, a processor carried on the chassis, a sensor system including at least one that is carried on the chassis, an autonomy system carried on the chassis, and a vehicle HD map arrangement carried on the chassis. The vehicle HD map arrangement includes one or more non-transitory computer readable storage media encoded with instructions that, when executed by the processor, cause the processor to perform obtaining a first set of data that is generated from at least a first map, obtaining a second set of data from the sensor system, and processing the first set of data and the second set of data, wherein processing the first set of data and the second set of data causes an HD map to be generated.

In still another embodiment, one or more non-transitory computer readable storage media encoded with instructions that, when executed by a processor, cause the processor to perform obtaining a first set of data, wherein the first set of data is generated by processing at least a first map from at least a first map source. The instructions are also arranged to cause the processor to perform obtaining a second set of data from at least one sensor located on the vehicle, and generating an HD map using the first set of data and the second set of data, wherein the HD map is generated using a vehicle map arrangement included on the vehicle.

A map engine architecture provides an end-to-end learned approach to provide an HD map for use on a vehicle such as an autonomous vehicle. The map engine uses multiple map data sources, in addition to sensor data provided by the vehicle, to generate the HD map for use on the vehicle using a machine learning model. The HD map may then be used by an autonomy system on the vehicle.

### DESCRIPTION

High definition (HD) maps are utilized to support the autonomous operation of vehicles. An HD map is generally a detailed representation of physical and semantic features in an environment. For autonomous vehicles, physical and semantic features of an environment may include curbs, lane lines, traffic signals, traffic signs, and effectively anything that is relevant to enabling traffic rules to be understood by the autonomous vehicles.

While HD map priors, or HD map sources which may be obtained from commercial sources, provide benefits to autonomy systems, the HD map priors often have inconsistent quality and may include inaccuracies which have not been identified. For example, map maintenance may need to be performed on HD map systems on a regular basis to address change detection and to provide up-to-date labeling.

While map data collected by autonomous vehicle enterprises may overcome some of the deficiencies of data associated with HD map priors. For example, an enterprise may collect map data and perform comprehensive validation on the collected map data to effectively ensure that the collected map data is accurate. However, labelling the collected map data, updating collected map data to match real-world changes, collecting the map data, storing the map data, and maintaining the map data may be operationally expensive. Further, sending map updates to relatively large fleets of vehicles may be data-intensive and, hence, relatively expensive.

Using data from map sources and data collected from a vehicle of an enterprise, an HD map that may be used by an autonomy system, or an HD autonomy map, may be created. Leveraging map data that is commercially available and data collected from a vehicle to generate an HD map effectively utilizes flexible and relatively cost-effective input data, and substantially provides robustness to real-world changes or updates. The creation of an HD map using data from map sources and data collected from a vehicle of an enterprise may effectively encode knowledge relating to map features including, but not limited to including, lane lines, curbs, and traffic signals. The encoding of such features may generally involve an occupancy grid, polylines, and/or bounding box annotations.

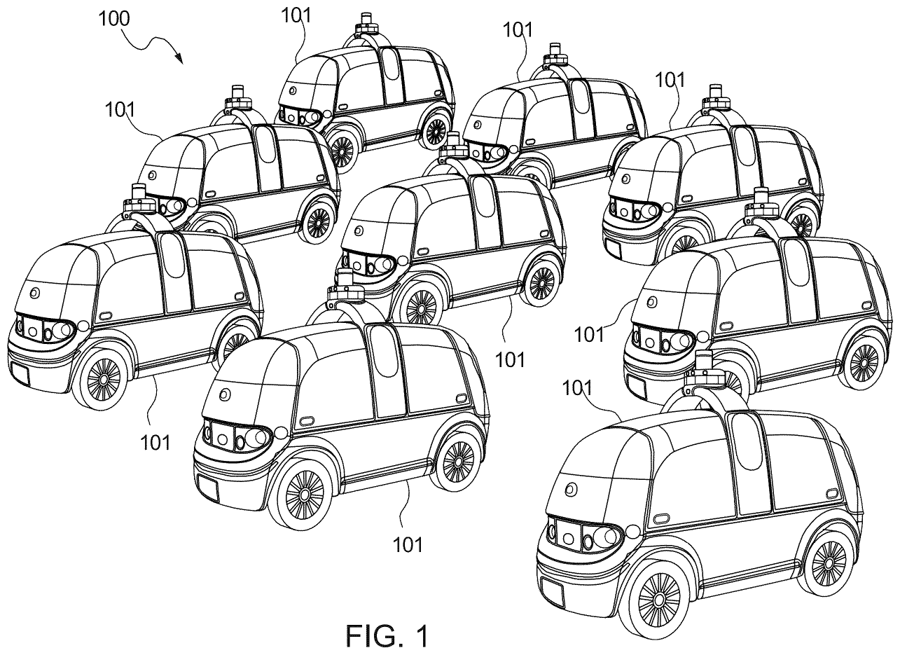

Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

While autonomous vehicle fleet 100 includes one or more autonomous vehicles 101 which are generally configured to transport and/or to deliver cargo, items, and/or goods, it should be appreciated that autonomous vehicle fleet 100 is not limited to including one or more autonomous vehicles 101. For example, autonomous vehicle fleet 100 may additionally, or alternatively, include autonomous vehicles (not shown) which are configured to transport and/or to deliver passengers.

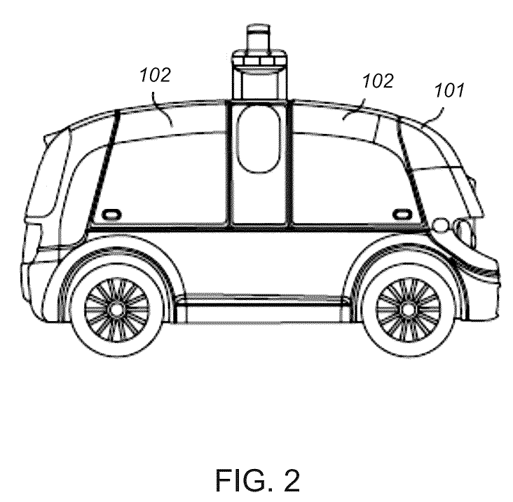

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

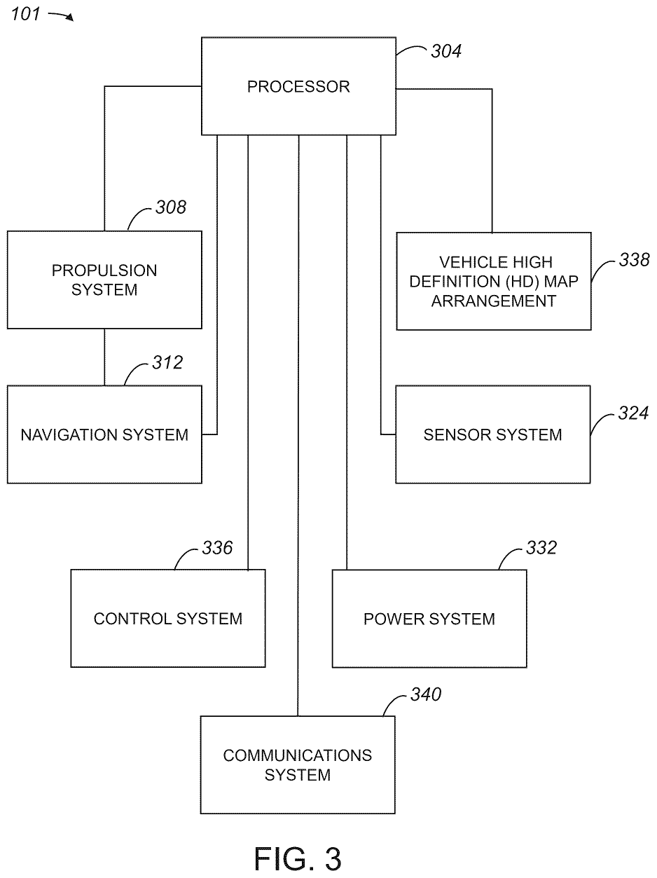

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. In the described embodiment, vehicle 101 includes a vehicle HD map arrangement 338 that provides maps that may be used by vehicle 101 to drive in an autonomous manner. It should be appreciated that processor 304, propulsion system 308, navigation system 312, sensor system 324, power system 332, communications system 340, and vehicle HD map arrangement 338 are all coupled to, or otherwise support on or carried on, a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312, and may utilize vehicle HD map arrangement 338, as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication system 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

An HD map may be created using one or more map data sources and data obtained from vehicle sensors on a vehicle. Such an HD map may be used by an autonomy system of a vehicle to enable the vehicle to drive autonomously. The map data sources, or map prior data, may include, but are not limited to including, two-dimensional imagery, a two-dimensional standard definition (SD) map, a three-dimensional point cloud map, and/or a three-dimensional HD map. As will be appreciated by those skilled in the art, an SD map may include information about roads, while an HD map may include additional information such as information relating to lanes on roads. A point cloud map may be associated with lidar systems, three-dimensional scanning, and photogrammetry. An SD map typically is of a lower resolution than a corresponding HD map. In one embodiment, map prior data may include data that is used as an input to another system, e.g., prior data may be map data that is used by an autonomy system of a vehicle.

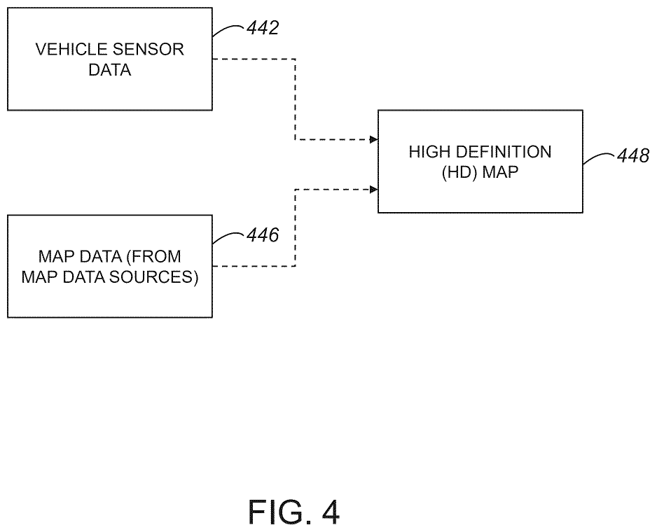

FIG. 4 is a block diagram representation of a system which uses map data sources and vehicle sensor data to create a HD map that may be used by an autonomy system of a vehicle in accordance with an embodiment. A HD map 448 that may be used by an autonomy system, or an HD autonomy map, may be used by an autonomous vehicle such as vehicle 101 of FIGS. 2 and 3 to enable vehicle 101 to drive autonomously.

HD map 448 is created or otherwise formed using map data 446 from map data sources and vehicle sensor data 442. That is, map data 446 and vehicle sensor data 442 may be obtained and processed, as for example using machine learning techniques, to create HD map 448. In one embodiment, vehicle sensor data 442 may be collected in an area in which map data 446 from one or more map sources is available, and maybe be used to predict what a vehicle such as vehicle 101 should “see.” Such prediction may be accomplished using machine learning techniques. Map data 446 may be obtained from one or more map data sources and, as previously discussed, may include two-dimensional map data and three-dimensional map data. Such map data may include satellite imagery data and aerial imagery data. It should be appreciated that the number of map data sources used to provide map data 446 may vary widely. The types of map data sources used to provide map data 446 may vary depending, for example, on the type of geography in an environment. That is, map sources that provide map data 446 may be selected based on factors such as geography. Some map sources may provide map data 446 for specific environments and, as such, multiple map sources may effectively be engaged to provide map data 446.

In addition, map data 446 may come in different formats and may have different qualities. As such, map data 446 may be processed and effectively converted into a format that is compatible with a map, e.g., a context map, substantially generated using vehicle sensor data 442. Vehicle sensor data 442 generally includes data obtained from a sensor system on a vehicle, e.g., sensor system 324 of vehicle 101 of FIG. 3. Vehicle sensor data 442 may generally include real world data such as map change events.

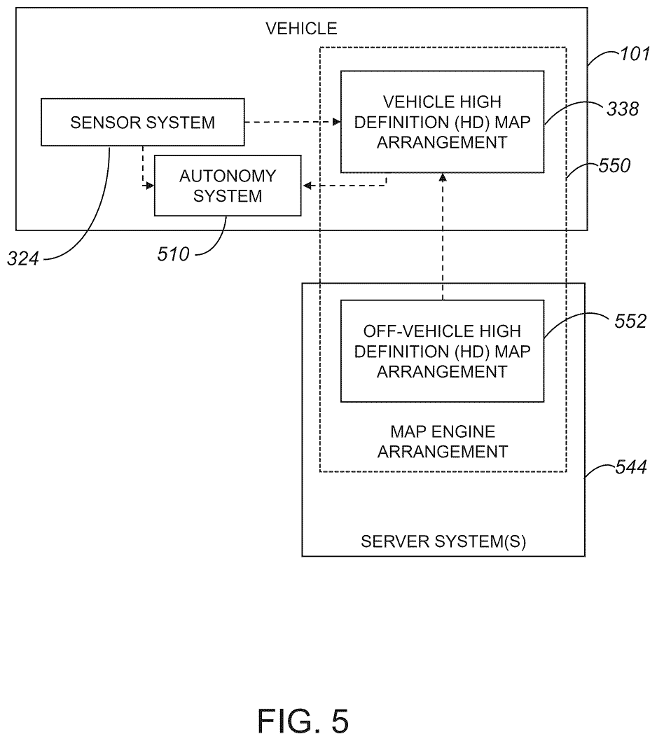

HD map 448 may be created by a map engine arrangement. A map engine arrangement may include hardware and/or software that is configured to process data to create HD map 448 and to maintain HD map 448. In one embodiment, a map engine arrangement may be distributed between a vehicle and a computing system that is offboard or remote with respect to the vehicle. With reference to FIG. 5, a map engine arrangement will be described in accordance with an embodiment. A map engine arrangement 550 includes vehicle HD map arrangement 338 and an off-vehicle HD map arrangement 552. Vehicle HD map arrangement 338 is, in one embodiment, onboard vehicle 101, and obtains data collected by sensor system 324. Off-vehicle HD map arrangement 552 is generally remote with respect to the vehicle, and may be implemented on one or more server systems 544. Off-vehicle HD map arrangement 552 may store information that may be accessed by vehicle HD map arrangement 338 as needed, using network communications. For example, due to storage and computational costs, some map data may be maintained by off-vehicle HD map arrangement 552 and accessed by vehicle HD map arrangement 338 when appropriate. Vehicle HD map arrangement 338 is arranged to provide data, e.g., data associated with an HD map, which may be used by an autonomy system 510 onboard vehicle 101.

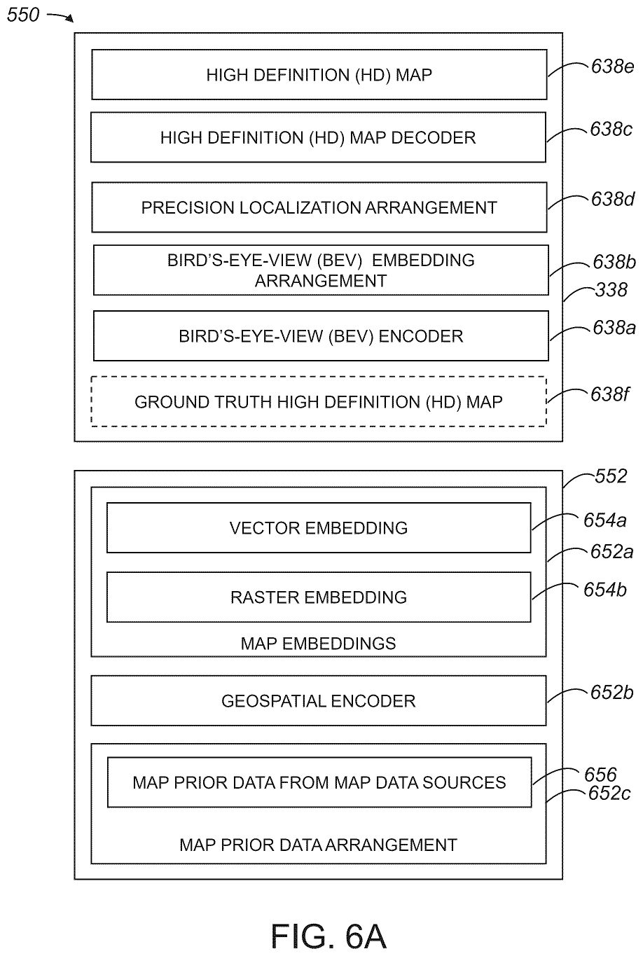

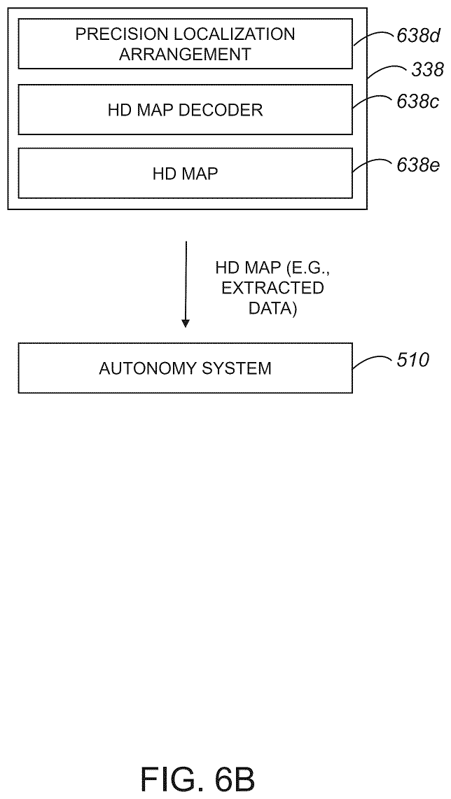

Referring next to FIG. 6A, a map engine arrangement, e.g., map engine arrangement 550 of FIG. 5, will be described in in accordance with an embodiment Map engine arrangement 550 includes vehicle HD map arrangement 338 and off-vehicle HD map arrangement 552.

Vehicle HD map arrangement 338 includes a birds-eye view (BEV) encoder 638a, a BEV embedding arrangement 638b, a HD map decoder 638c, a precision localization arrangement 638d, an HD map 638e, and an optional ground truth HD map 638f. Off-vehicle HD map arrangement 552 includes a map embeddings 652a, a geospatial encoder 652b, and a map prior data arrangement 652c. Map embeddings 652a includes a vector embedding 654a, a raster embedding 654b. Map prior data arrangement 652c includes map prior data from map data sources 656. In one embodiment, map prior data arrangement 652c may provide information to geospatial encoder 652b which then substantially provides map embeddings 652a.

Data from one or more vehicle sensors, e.g., sensors included in sensor system 324 of vehicle 101 of FIG. 3, is provided to BEV encoder 638a which may process the data to effectively generate output that includes a bird's eye view of the environment around the vehicle. In general, a bird's eye view of an environment or a bird's eye view representation involves encoding a two-dimensional grid around a vehicle. Output from BEV encoder 638a is provided to BEV embedding arrangement 638b.

Map prior data arrangement 652c processes map prior data from map data sources 656, and provides input to geospatial encoder 652b. Geospatial encoder 652b processes the input provided by map prior data arrangement 652c and produces map embeddings 652a which may include, but are not limited to including, a vector embedding 654a and/or a raster embedding 654b. It should be appreciated that vector embedding 654a may combine spatial data and geometric shapes, while raster embedding 654b may be used to effectively display two-dimensional imagery, topographic maps, lidar data, and/or other geographic data.

Vector embedding 654a and/or raster embedding 654b are concatenated with the output from BEV encoder 638a by BEV embedding arrangement 638b. BEV embedding arrangement 638b provides input to precision localization arrangement 638d which uses the input, in addition to the vector embedding and/or the raster embedding, to enable the vehicle to be localized. BEV embedding arrangement 638b provides input to HD map decoder 638c to create HD map 638e.

Map prior data arrangement 652c includes multiple map prior data from map data sources 656 that is used by, or consumed by, geospatial encoder 652b. That is, aligned map prior data from map data sources 656 may be aligned such that map prior data from map data sources 656 may be substantially combined to form an embedding representation. Map prior data from map data sources 656 may be from sources that have different price points, and may include both vector and raster data. In order to use map prior data from data sources 656, map prior data layers are geographically aligned to enable the map prior data layers to be tokenized to create input for geospatial encoder 652b. It should be appreciated that map prior data from data sources 656 may have overlapping coverage or non-overlapping coverage. For example, for environmentally complex areas such as dense urban areas, high density maps and point cloud maps with overlapping coverage may be desirable. For less complex areas such as highways and rural roads, standard density maps and imagery may be used. As will be appreciated by those skilled in the art, to incorporate HD map prior data, a map tokenizer may be used.

Geospatial encoder 652b is generally arranged to ingest aligned map prior data from map data sources 656, or multiple layers of aligned prior map data, to substantially produce multiple embedding output layers associated with map embeddings 652a. Geospatial encoder 652b may be multimodal. That is, geospatial encoder 652b may be arranged to ingest input data and to generate map embeddings 652a associated with an output map. The input data and embeddings may be in formats including, but not limited to including, raster, vector, and/or attribute. Geospatial encoder 652b may also be tiled, or otherwise able to process multiple geographically-adjacent tiled regions substantially in parallel and to produce consistent embeddings such as map embeddings a 652a.

Map embeddings 652a, or the output from geospatial encoder 652b, may be in the form of tiles generated across a region, e.g., an operating region of a particular autonomous vehicle. Map embeddings 652a may include encoded prior data for HD map 638e decoding substantially without an intermediate representations. In one embodiment, relatively complex properties of map prior data from map data sources 656 may be captured, e.g., as part of an end-to-end training process. The properties of map prior data from map data sources 656 that are captured may include, but are not limited to including, data reliability, geographic accuracy, and/or semantic attributes. Semantic attributes may include, but are not limited to including, curbs, lane lines, traffic signals, traffic signs such as stop signs, edges of buildings, poles, etc. Map embeddings 652a may generally be aligned to a geographic frame such as a global reference frame.

Map embeddings 652a are effectively generated from map prior data from map data sources 656 associated with multiple data sources, and are a learned set of map features. As a result, the coverage associated with map embeddings 652a may be substantially uniform, and relevant properties associated with map prior data from map data sources 656 may be captured. Map embeddings 652a are generally provided to BEV encoder 638a.

In one embodiment, map prior data from map data sources 656 may be used to predict features in a map. That is, map changes may be substantially predicted using map prior data from map data sources 656. The use of machine learning may enable map changes to be predicted and used to effectively train a vehicle HD map arrangement 338 to effectively update HD map 638e. When machine learning is used to create HD map 638e, map prior data from map data sources 656 may be used in conjunction with input map prior data to effectively detect where and how map prior data is outdated. By way of example, in a fleet of vehicles, if multiple vehicles spot or otherwise identify the same change in an HD map such as HD map 638e, the change may be identified as being likely to be correct, and HD map 638e may be updated substantially permanently after the same change is identified a particular number of times. When a map change is identified as substantially permanent, updated prior map data may then be used as an input to geospatial encoder 652b and, as such, information provided to BEV encoder 638a for embedding purposes may effectively be more accurate.

BEV encoder 638a is arranged to essentially combine sensor data from sensor systems of a vehicle in a top-down embedding space. The sensor data may include, but is not limited to including, data obtained from cameras such as thermal cameras, data obtained from lidars, and/or data obtained from radars. BEV encoder 638a may account for changes in real-world conditions by utilizing sensor data. BEV embedding arrangement 638b encodes relevant live data collected from sensors on a vehicle for relatively precision localization by precision localization arrangement 638d and HD map decoding by HD map decoder 638c. It should be appreciated that the encoded live data may substantially include data relating to locations for which map prior data from map data sources 656 may be incomplete, inaccurate, outdated, and/or non-existent. In one embodiment, HD map decoder 638c may be a neural network.

Live data encoded by BEV embedding arrangement 638b generally is not aligned to a geographic frame such as a global reference frame. Rather, the live data or BEV embeddings encoded by BEV embedding arrangement 638b is typically centered on a reference frame associated with a vehicle, or a local vehicle-aligned reference frame. As such, to enable map embeddings 652a to be substantially combined with BEV embeddings encoded by BEV embedding arrangement 638b, map embeddings 652a and BEV embeddings are aligned by precision localization arrangement 638d. In one embodiment, precision localization arrangement 638d may perform a convolution operation on map embeddings 652a and BEV embeddings using phase correlation to effectively recover an offset between map embeddings 652a and BEV embeddings. Once the offset is recovered or otherwise determined, the offset may be used to align a local vehicle-aligned frame with a global reference frame.

HD map 638e, which is a map that is online with respect to a vehicle, is effectively generated after map embeddings 652a and BEV embeddings are concatenated to form a combined embedding, and subsequently decoded by HD map decoder 638c into vector HD map features. HD map 638e has features that are effectively derived from a combination of map prior data from map data sources 656 that is encoded using geospatial encoder 652b and sensor data obtained from sensors on the vehicle. Map embeddings 652a may provide data that effectively compensates for occlusions and relatively limited ranges associated with sensors, and BEV embeddings provide data that effectively compensates for features that may be missing or inaccurate in map embeddings 652a.

In one embodiment, optional ground truth HD map 638f may include labels for locations that may be included in data logs associated with sensors on a vehicle. Optional ground truth HD map 638f may facilitate end-to-end training used to generate HD map 638e, and is generally used at training time, and not while a vehicle is operating. The end-to-end training may include, but is not limited to including, identifying weights for geospatial encoder 652b, BEV encoder 638a, and HD map decoder 638c that are appropriate for creating HD map 638e. The use of ground truth HD map 638f for training enables the generation of HD map 638e to be based at least in part on learnings taken from the training, as the model that produces HD map 638e may compare its predictions with ground truth HD map 638f and, as such, essentially learn where inaccuracies such as missing or inaccurate feature predictions arose.

As shown in FIG. 6B, data extracted from or otherwise obtained from precision localization arrangement 638d and from HD map decoder 638c may be provided to autonomy system 510, along with HD map 638e. That is, autonomy system 510 may effectively use relevant pieces of data provided by precision localization arrangement 638d and HD map decoder 638c to facilitate the use of HD map 638e to navigate and to operate.

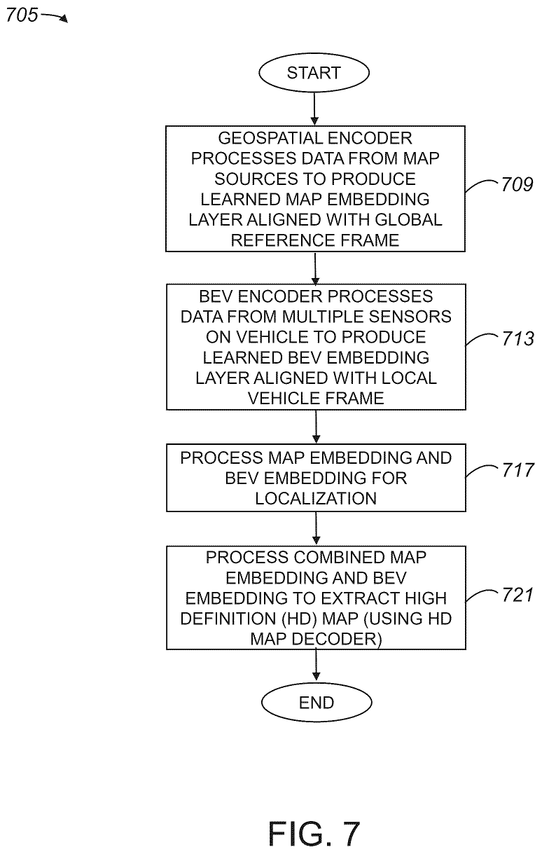

In general, a map engine arrangement may generate an HD map for use by an autonomy system to facilitate the autonomous operation of a vehicle. FIG. 7 is a process flow diagram which illustrates a method of generating an HD map for use with or by an autonomy system in accordance with an embodiment. A method 705 of generating an HD map begins at a step 709 in which a geospatial encoder processes data obtained from map sources to effectively produce a learned map embedding layer that is aligned with a global reference frame.

Once the learned map embedding layer is produced or generated, a BEV encoder processes data from multiple sensors on a vehicle to produce a learned BEV embedding layer that is aligned with a local vehicle frame in a step 713. The learned map embedding and the learned BEV embedding are processed for localization in a step 717. Then, in a step 721, the learned map embedding and the learned BEV embedding are combined, e.g., aligned or concatenated. An HD map decoder may process the learned map embedding and the learned BEV embedding to produce an HD map. The method of generating an HD map is completed upon the HD map decoder processing the learned map embedding and the learned BEV embedding.

A HD map associated with a vehicle may generally be arranged to cover an operational area of the vehicle. That is, a HD map effectively includes maps which cover an area within which a vehicle operates or is expected to operate. The amount or size of data that may be associated with the generation and maintenance of a HD map for an operational area may be relatively large, as for example if the operational area is relatively large. In one embodiment, an entropy-based loss may be applied to a map embedding or a map embedding layer in order to support a relatively large amount of data associated with a HD map. In such an embodiment, by effectively optimizing for relatively low-entropy map embeddings, map embeddings may become more easily compressible by encoding approaches such as run-length encoding (RLE) approaches.

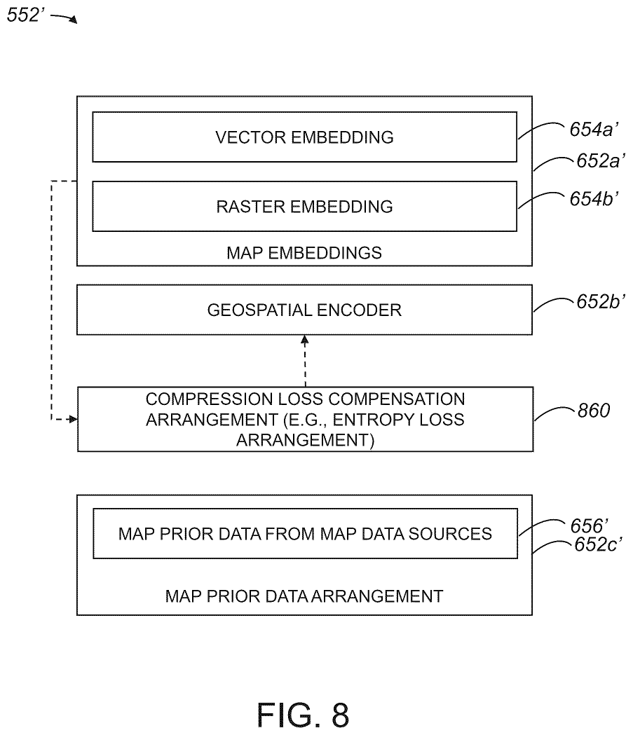

FIG. 8 is a diagrammatic representation of an off-vehicle HD map arrangement, e.g., off-vehicle HD map arrangement 552 of FIG. 2, which accounts for entropy loss in accordance with an embodiment. Off-vehicle HD map arrangement 552′ includes map embeddings 652a′ that may include, but are not limited to including, a vector embedding 654a′ and a raster embedding 654b′. Off-vehicle HD map arrangement 552′ also includes geospatial encoder 652b′, map prior arrangement 652c′ which includes map prior data from map data sources 656′, and a compression loss compensation arrangement 860.

Compression loss compensation arrangement 860 processes map embeddings 652a′ and provides feedback to geospatial encoder 652b′. The inclusion of compression loss compensation arrangement 860 enables task-based lossy compression schemes for map prior data from map data sources 656′. In one embodiment, the enablement of such task-based lossy compression schemes facilitates streamlining updates to map prior data from map data sources 656′ over a network, e.g., an LTE network. Compression loss compensation arrangement 860 may be any suitable arrangement that addresses loss.

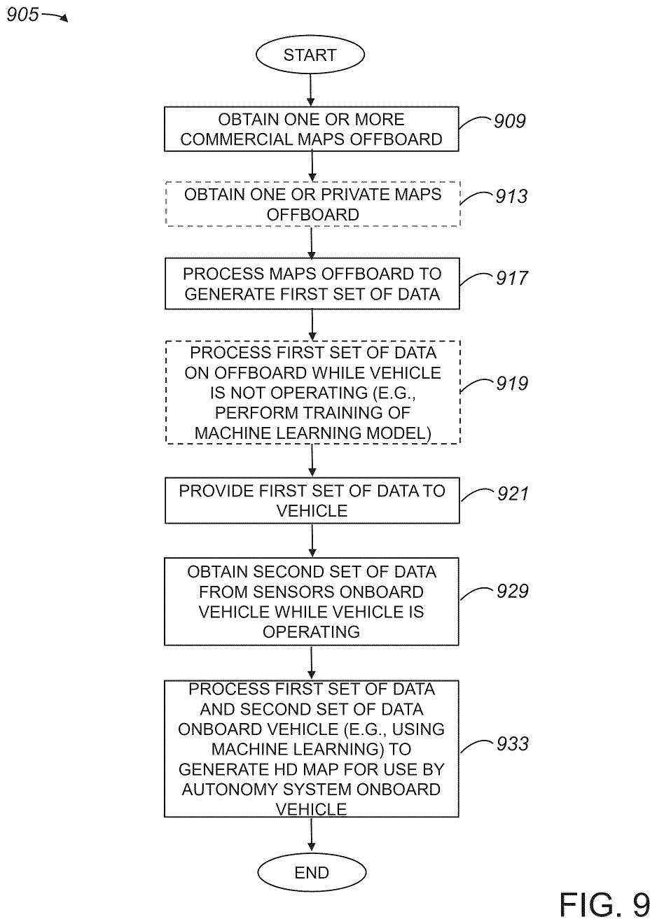

With reference to FIG. 9, a general method of providing an HD map for use by an autonomy system of a vehicle will be described in accordance with an embodiment. A method 905 of providing an HD map for use by an autonomy system begins at a step 909 in which one or more commercial maps are obtained offboard a vehicle, e.g., by a server system which is in communication with the vehicle over a network. The commercial maps may generally be third-party maps, and may include, but are not limited to including, satellite maps, aerial maps, and maps derived from point cloud data.

In an optional step 913, one or more private, e.g., first-party or proprietary, maps may be obtained offboard. From step 909, or from optional step 913, process flow proceeds to a step 917 in which the maps are processed offboard to generate a first set of data. The first set of data may include map embeddings.

T first set of data may optionally be processed offboard while the vehicle is not operating in an optional step 919. Processing the first set of data may include, but is not limited to including, comparing the first set of data to ground truth data and adjusting the first set of data to address one or more inconsistencies between the first set of data to the ground truth data. It should be appreciated that processing the first set of data may include training, as for example training an overall map engine arrangement that utilizes machine learning in the process of generating an HD map.

The first set of data is provided to the vehicle in a step 921. In general, the first set of data is provided before the deployed on a mission. It should be appreciated, however, that in the event that the total size of the first set of data is relatively large, a subset of the first set of data may instead be provided before the vehicle is deployed on a mission. For example, a subset of the first set of data that is relevant to the area in which the vehicle is to be deployed may be provided.

Once the vehicle starts operating, a second set of data may be obtained from sensors onboard the vehicle in a step 929. The second set of data may generally provide one or more views of an environment around the vehicle. After the second set of data is obtained, the first set of data and the second set of data are processed onboard the vehicle, as for example using a machine learning model, in a step 933 to generate an HD map that may be used by an autonomy system onboard the vehicle. That is, an overall map engine arrangement generates an HD map for use by an autonomy system, and the method of generating an HD map is then completed.

Although only a few embodiments have been described in this disclosure, it should be understood that the disclosure may be embodied in many other specific forms without departing from the spirit or the scope of the present disclosure. By way of example, while map prior data has been described as being associated with two-dimensional imagery, a two-dimensional SD map, a three-dimensional point cloud map, and/or a three-dimensional HD map, map prior data may include data from other sources. Two-dimensional imagery may include, but is not limited to including, satellite or aerial imagery. Other suitable sources of map prior data may include, but are not limited to including, advanced driver assistance system maps, raster maps, and vector maps. It should be appreciated that the resolution associated with various maps may vary.

While the creation of an HD map using data from map sources and data collected from a vehicle has been described as including encoding knowledge relating to map features including, but not limited to including, lane lines, curbs, and traffic signals, it should be understood that other types of map features may effectively be encoded. For instance, maps obtained from a map source may not include information relating to map features or other information associated with an underpass, or a road that is underneath an overpass. Data collected from a vehicle may provide information relating to an underpass. Satellite imagery, for example, does not provide imagery for a road that passes under an overpass, and information relating to such a road may be provided by sensor data collected from a vehicle.

The use of map prior data may facilitate precision localization against map embeddings. Facilitating precision localization may reduce dependencies on a global navigation satellite system (GNSS) in some instances. It should be appreciated, however, that the HD map of the disclosure may be used in cooperation with a GNSS to enable a vehicle to drive autonomously.

When map prior data is updated, map embeddings may be updated to account for updates in the map prior data. Such updates to map embeddings may occur periodically, as for example based on a predetermined schedule, and all map prior data that has been updated since a previous update may be accounted for. Alternatively, such updates to map embeddings may occur substantially on demand, or when the map prior data is updated. In other words, map embeddings may be updated at approximately the time at which map prior data is updated. It should be appreciated, however, that an HD map and outputs of a geospatial encoder, as for examples map embeddings, are not limited to being updated periodically or substantially on demand. For example, map embeddings may also be updated when a predetermined number or amount of map prior data is obtained.

In one embodiment, a ground truth HD map may be provided to a geospatial encoder, a BEV encoder, and an HD map decoder. It should be appreciated, however, that providing a ground truth HD map to a geospatial encoder, a BEV encoder, and/or an HD map decoder may occur in a training setting and not in an operation setting, e.g., not when a vehicle is on a mission.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

While an autonomous vehicle has been described as being arranged to transport goods, it should be appreciated that an autonomous vehicle may additionally, or alternatively, be configured to transport passengers. That is, an autonomous vehicle is not limited to transporting goods, and may be arranged to transport or otherwise carry occupants, e.g., passengers.

The embodiments may be implemented as hardware, firmware, and/or software logic or instructions embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a computer-readable tangible storage medium. A tangible medium may be substantially any computer-readable medium that is capable of storing logic, instructions, or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining at least a first map from at least a first map source on a first map arrangement;
processing the at least first map to generate a first set of data;
providing the first set of data to a vehicle, wherein the vehicle includes an autonomy system and at least one sensor;
obtaining a second set of data from the at least one sensor; and
processing the first set of data and the second set of data using a second map arrangement, the first map arrangement and the second map arrangement forming a map engine arrangement, wherein processing the first set of data and the second set of data causes a high definition (HD) map to be generated.

2. The method of claim 1 further including:
providing the HD map to the autonomy system.

3. The method of claim 1 wherein the first map arrangement is offboard the vehicle and the second map arrangement is onboard the vehicle.

4. The method of claim 3 wherein obtaining the second set of data from the at least one sensor includes obtaining the second set of data while the vehicle is operating.

5. The method of claim 4 wherein the second map arrangement includes a machine learning model, the method further including:
processing the first set of data to train the machine learning model while the vehicle is not operating before processing the first set of data and the second set of data using the second map arrangement while the vehicle is operating.

6. The method of claim 1 wherein the first map arrangement includes a geospatial encoder, wherein the first set of data includes at least a first map embedding aligned with a global reference frame.

7. The method of claim 6 wherein the second map arrangement includes a bird's eye view (BEV) encoder, the method further including:
processing the second set of data using the second map arrangement to produce a first BEV embedding aligned with a vehicle reference frame, wherein processing the first set of data and the second set of data includes combining the first map embedding and the first BEV embedding to extract the HD map.

8. A vehicle comprising:
a chassis;
a processor carried on the chassis;
a sensor system including at least one sensor, the sensor system carried on the chassis;
an autonomy system carried on the chassis; and
a vehicle high definition (HD) map arrangement carried on the chassis, the vehicle HD map arrangement including one or more non-transitory computer readable storage media encoded with instructions that, when executed by the processor, cause the processor to perform
obtaining a first set of data that is generated from at least a first map,
obtaining a second set of data from the sensor system, and
processing the first set of data and the second set of data, wherein processing the first set of data and the second set of data causes an HD map to be generated.

9. The vehicle of claim 8 wherein the instructions further cause the HD map to be provided to the autonomy system.

10. The vehicle of claim 9 wherein obtaining the second set of data from the at least one sensor includes obtaining the second set of data while the vehicle is operating.

11. The vehicle of claim 10 wherein the vehicle HD map arrangement includes a machine learning model, and wherein the instructions further cause:
processing the first set of data to train the machine learning model while the vehicle is not operating before processing the first set of data and the second set of data while the vehicle is operating.

12. The vehicle of claim 9 wherein the first set of data includes at least a first map embedding aligned with a global reference frame.

13. The vehicle of claim 12 wherein the vehicle HD map arrangement includes a bird's eye view (BEV) encoder, and wherein the instructions further cause:
processing the second set of data using the vehicle HD map arrangement to produce a first BEV embedding aligned with a vehicle reference frame, wherein processing the first set of data and the second set of data includes combining the first map embedding and the first BEV embedding to extract the HD map.

14. One or more non-transitory computer readable storage media encoded with instructions that, when executed by a processor, cause the processor to perform:
obtaining a first set of data, wherein the first set of data is generated by processing at least a first map from at least a first map source;
obtaining a second set of data from at least one sensor, the at least one sensor being located on a vehicle; and
generating a high definition (HD) map using the first set of data and the second set of data, wherein the HD map is generated using a vehicle map arrangement included on the vehicle.

15. The one or more non-transitory computer readable storage media of claim 14 further configured to cause the processor to perform:
providing the HD map to an autonomy system, the autonomy system being included on the vehicle.

16. The one or more non-transitory computer readable storage media of claim 14 wherein the vehicle map arrangement included in a map engine arrangement that includes an off-vehicle map arrangement that is offboard the vehicle, wherein the first set of data is obtained from the off-vehicle map arrangement.

17. The one or more non-transitory computer readable storage media of claim 16 wherein obtaining the second set of data from the at least one sensor includes obtaining the second set of data while the vehicle is operating.

18. The one or more non-transitory computer readable storage media of claim 17 wherein the vehicle map arrangement includes a machine learning model, the one or more non-transitory computer readable storage media further configured to cause the processor to perform:
processing the first set of data to train the machine learning model while the vehicle is not operating before processing the first set of data and the second set of data using the second map arrangement while the vehicle is operating.

19. The one or more non-transitory computer readable storage media of claim 14 wherein the first set of data includes at least a first map embedding aligned with a global reference frame.

20. The one or more non-transitory computer readable storage media of claim 19 wherein the vehicle map arrangement includes a bird's eye view (BEV) encoder, the one or more non-transitory computer readable storage media further configured to cause the processor to perform:
processing the second set of data using the vehicle map arrangement to produce a first BEV embedding aligned with a vehicle reference frame, wherein processing the first set of data and the second set of data includes combining the first map embedding and the first BEV embedding to extract the HD map.
